(19) United States
(12) Patent Application Publication
(10) Pub. No.: US 2016/0314477 A1
(43) Pub. Date: Oct. 27, 2016

(54) IDENTIFYING ENTITIES TRENDING IN A PROFESSIONAL COMMUNITY

(71) Applicant: LinkedIn Corporation, Mountain View, CA (US)

(72) Inventor: Viet Thuc Ha, Santa Clara, CA (US)

(73) Assignee: LinkedIn Corporation, Mountain View, CA (US)

(21) Appl. No.: 14/696,831

(22) Filed: Apr. 27, 2015

(51) Int. Cl. G06Q 30/02; G06F 17/30

(52) U.S. Cl. CPC G06Q 30/0201; G06F 17/30864; G06F 17/30595

(57) ABSTRACT

A system, method, and apparatus are provided for identifying entities trending within a professional community, such as member of a professional social network. The system collects “share” activity and/or other types of activities conducted by members of the community in which they generate or disseminate (textual) content. From the collected share activity, trending terms are identified and ranked according to scores that reflect the change in frequency of usage of the terms over time. The most relevant shares for each trending term are identified and used to identify names of entities that correspond to (e.g., include) the terms. Reasons indicating why each trending entity is trending are also derived from the share activity. A display or presentation is provided of top trending entities, within one or more segments of the professional community, which includes the reasons and allows a viewer to quickly identify the reason a given entity is trending.

### BACKGROUND

This disclosure relates to the field of computers. More particularly, a system, method, and apparatus are provided for identifying entities that are trending within a professional community such as a professional network.

Recognizing entities (e.g., people, events, things) that are trending within a professional community, and presenting a display of those trending entities with context and in a meaningful manner—not just as a few key words—can be difficult. For example, different members of a professional community may refer to a given entity with different names or descriptions, and using different words. In addition, what may appear to be separate trending entities may actually be two related entities trending for the same reason or reasons. Yet further, existing schemes for identifying trends fail to provide the context or reason for a trend.

### DESCRIPTION OF THE FIGURES

FIG. 1 is a block diagram depicting a computing environment in which trending professional entities are identified, with context, in accordance with some embodiments.

FIG. 2 is a flow chart illustrating a method of identifying entities trending in a professional community, in accordance with some embodiments.

FIG. 3 depicts an apparatus for identifying entities trending in a professional community, in accordance with some embodiments.

### DETAILED DESCRIPTION

The following description is presented to enable any person skilled in the art to make and use the disclosed embodiments, and is provided in the context of one or more particular applications and their requirements. Various modifications to the disclosed embodiments will be readily apparent to those skilled in the art, and the general principles defined herein may be applied to other embodiments and applications without departing from the scope of those that are disclosed. Thus, the present invention or inventions are not intended to be limited to the embodiments shown, but rather are to be accorded the widest scope consistent with the disclosure.

In some embodiments, a system, method, and apparatus are provided for identifying entities that are trending in the professional world or in a relatively large professional community, such as the community of members of the professional network provided by LinkedIn® Corporation. A trending entity may be a person, a group of people, a company or other organization, a product, or some other entity active or known in the professional community.

In these embodiments, the entities are identified by analyzing communications by and/or between members of the community. In some implementations, for example, “share” activities of members of the community are analyzed, particularly textual input made by members when they share content (e.g., a news article, a photograph, a white paper), post a comment or message, or take some other action in which they disseminate textual information.

Because the professional members' actions involving trending entities will tend to include identifying or alluding to a context or reason for the popularity of a given entity, the captured activity allows a presentation of the top trending entities to be accompanied by substantive contextual content, or possibly a link to a document, that will allow a viewer to quickly understand the reason(s) why a given entity is trending.

The accompanying context thus is much more meaningful than simply displaying the name of the trending entity, or a set of key words. A site or system that attempts to identify popular trends, in contrast, may simply list names of people who are often mentioned in the news, or the most popular key words that users have submitted as search terms (e.g., at a search engine). These systems do not provide contexts for trending entities, therefore requiring one to further investigate the list of entities in order to determine why a given entity is popular.

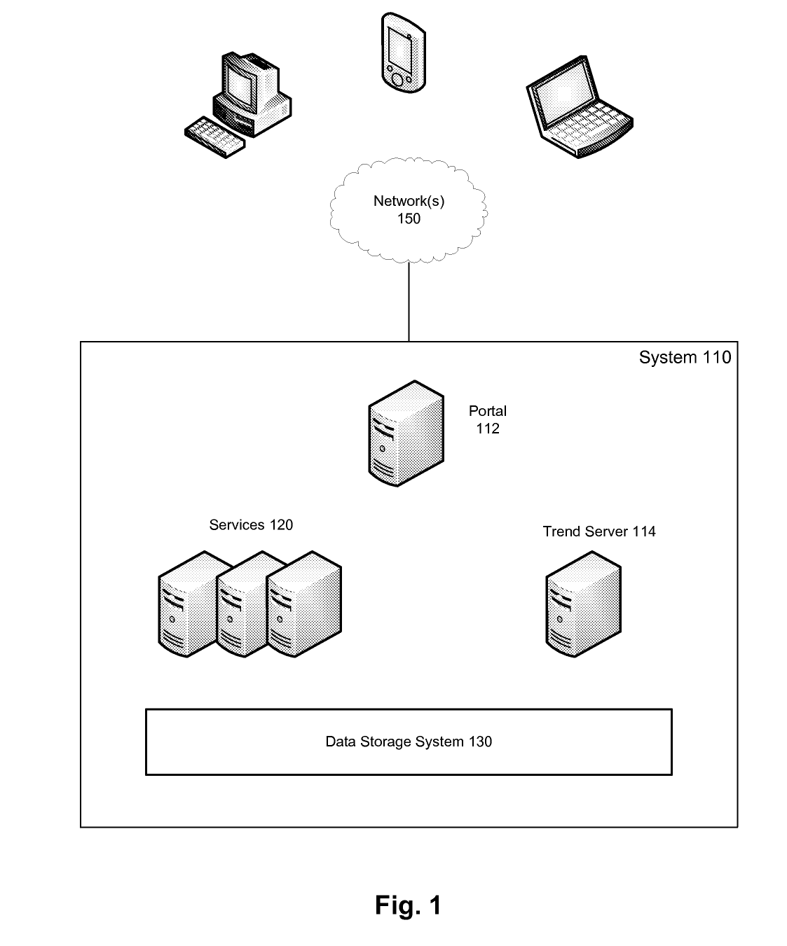

FIG. 1 is a block diagram depicting a computing environment in which trending professional entities are identified, with context, according to some embodiments.

System 110 of FIG. 1 is (or is part of) a data center that supports or hosts an online application or service that features a community or network of professional users, such as a professional network or a professional social network offered by LinkedIn® Corporation. Users of system 110 may be termed members because they may be required to register with the system in order to use the application or service. Members may be identified and differentiated by username, electronic mail address, telephone number, and/or some other unique identifier.

Users/members of a service or services hosted by system 110 connect to the system via client devices, which may be stationary (e.g., desktop computer, workstation) or mobile (e.g., smart phone, tablet computer, laptop computer). In order to interact with the system (e.g., to view content, submit or edit content) the client devices operate suitable client applications, such as a browser program or an application designed specifically to access a service offered by system 110.

Client devices are coupled to system 110 via direct channels and/or one or more networks 150 or other shared channels, which may include the Internet, intranets, and/or other networks, and may incorporate wired and/or wireless communication links.

Via these devices and the client applications, members are able to post new information to the professional community, receive information posted by other members, exchange messages with other members, and otherwise interact within the community. Various mechanisms or functions may be offered by system 110 to promote such information exchange, to allow members to “share” or “like” some particular content, to comment upon or forward the content, to upload or create a link to content, and so on.

Among the information presented to members via their client devices, system 110 may serve a presentation of top trending professional entities. These entities may be drawn from the professional community hosted by the system or the entire professional world that includes the community. Also, or instead, top trending entities may be presented in different categories, by industry (e.g., accounting, computer networking, financial services, telecommunications), functional area (e.g., human resources, marketing, customer service), seniority (e.g., of individuals within organizations), organization size, location, etc.

Interactive user/member sessions with system 110 are generally made through portal 112, which may comprise a web server, an application server, and/or some other gateway or entry point. The portal through which a given session is established may depend on the member's device or method of connection. For example, a user of a mobile client device may connect to system 110 via a different portal (or set of portals) than a user of a desktop or workstation computer.

System 110 also includes trend server 114, data storage system 130, and various services represented by services 120, which may be hosted by any number of computing machines. Trend server 114 analyzes activity of members of the professional community, as further described below, to identify the trending professional entities within any suitable time period or periods (e.g., the last 8 hours, the last 24 hours, the last week, the last month).

Data storage system 130, which may be a distributed data storage system, and/or components of the data storage system (e.g., separate storage engines), include appropriate data storage devices (e.g., disks, solid-state drives), and store data used by portal 112, trend server 114, services 120, and/or other components of system 110 not depicted in FIG. 1.

Among services 120 may be one or more individual computer servers configured to serve content, track/record activity within system 110, maintain member profiles, and/or support other services.

For example, a profile service or server may maintain profiles of members of the service(s) hosted by system 110, which may be stored in data storage system 130 and/or elsewhere. An individual member's profile may include or reflect any number of attributes or characteristics of the member, including personal (e.g., gender, age or age range, interests, hobbies, member ID), professional (e.g., employment status, job title, job location, employer or associated organization, industry, functional area or role, skills, endorsements, professional awards, seniority), social (e.g., organizations the user is a member of, geographic area of residence, friends), educational (e.g., degree(s), university attended, other training), etc. A member's profile, or attributes or dimensions of a member's profile, may be used in various ways by system components (e.g., to identify or characterize a member who shared or received information, to characterize a trending entity that is a member of the community, to characterize content, to select content to serve to a member, to record a content-delivery event).

Organizations may also be members of the service(s) offered by system 110 (i.e., in addition to individuals), and may have associated descriptions or profiles comprising attributes such as industry, size, location, goal or purpose, etc. An organization may be a company, a corporation, a partnership, a firm, a government agency or entity, a not-for-profit entity, a group or collection of associated members, or some other entity formed for virtually any purpose (e.g., professional, social, educational). Either or both organizations and individual members may “follow” and/or be followed by other members, may share and/or received shared information, may initiate and receive communications with other members, may post content and/or receive content posted by other members, etc.

A content service or server may maintain one or more repositories of content items for serving to members (e.g., within data storage system 130 and/or elsewhere), an index of the content items, and/or other information useful in serving content to members. Illustratively, a content server may serve on the order of hundreds of millions of items or objects every day. A content store may include various types of sponsored and/or unsponsored content items for serving to members and/or for use by various components of system 110, which may be generated within the system or by external entities. A content service (or some other component of system 110) may include a recommendation module for recommending specific content to serve to a member.

A tracking service or server may monitor and record (e.g., within data storage system 130 and/or elsewhere) activity of system 110 and/or members. For example, whenever content or a communication is served by the system (e.g., to a client device), the tracking server may be informed of what is served, to whom (e.g., which member), when it was served, and/or other information. Similarly, the tracking server may also receive notifications of member actions regarding content actions and communications, to include identities of the member and the content acted upon, the action that was taken, when the action was taken, etc. Illustrative actions that may be captured include, but are not limited to, clicks/taps/pinches (on the content, on a logo or image), conversions, follow-on requests, visiting a page associated with a subject or provider of the content, taking some other action regarding the content (e.g., commenting on it, sharing it, following its provider, liking it), and so on.

Members of a service hosted by system 110 have corresponding “home” pages (e.g., web pages, content pages) on the system, which they may use to facilitate their activities with the system and with each other, to form connections/relationships with other members, to view their connections and/or information regarding their connections, to view trending entities, to review their profiles, to inform friends and/or colleagues of developments in their lives/careers, to send/receive communications, etc. These pages (or information provided to members via these pages) are available to some or all other members. Members' home pages may be stored within data storage system 130 or elsewhere.

Specific activities of members of the professional community hosted by system 110 may be monitored by individual activity-specific services, or may be monitored by a content service, a tracking service, or some other larger service. Thus, a distinct “share” service may be operated to support sharing of content and/or other information between members. The share service may enable one member to generate information or content (e.g., by manual entry, by uploading, by linking) and share that information with some or all other members (e.g., members with which the one member is associated, members that “follow” the one member).

For example, one member may type a comment or reference to a real-world event and operate a “share” control or button of a user interface offered by a client application operating on the member's client device to have that information shared with other members. This share activity may include a link to a document or other content item that is internal or external to system 110 in addition to or instead of including a textual and/or graphical message entered by the one member. The share service thus supports dissemination of one member's information among other members.

System 110 may include yet other components, services, and/or servers not illustrated in FIG. 1. Also, functionality attributed herein to system 110 may be distributed among its components in an alternative manner, such as by merging or further dividing functions of one or more components, or may be distributed among a different collection of components. Yet further, while depicted as separate and individual hardware components (e.g., computer servers) in FIG. 1, one or more of portal 112, trend server 114, and services 120 may alternatively be implemented as separate software modules executing on one or more computer servers. Thus, although only a single instance of a particular component of system 110 may be illustrated in FIG. 1, it should be understood that multiple instances of some or all components may be utilized.

In some embodiments, trend server 114 periodically (or continually) analyzes share activities of members of the professional community of system 110. Each share activity identifies the member who initiated the activity, as well as the context of the share, which may include some or all text entered by the sharing member (e.g., a comment; a statement; a reference regarding some event, person, organization, or other entity), and possibly content identified or linked by the member (e.g., a document). Advantageously, contexts of share activities exchanged between members of the professional community often include full sentences, statements, or phrases that reflect a reason the sharing member thought that the focus of the share (e.g., an entity referenced in the share) was notable.

As described above, the sharing member has associated attributes (e.g. industry, seniority, employer), any of which may be used to categorize the share, the share context, and/or any entities mentioned or otherwise identified in the share activity. Similarly, the text of the share context and/or any linked content may be analyzed to categorize its subject matter.

Subsequently, the trend server identifies the most commonly occurring terms among shares (and/or other activities) initiated by some or all members of the community and/or among members having some attribute(s) in common (e.g., industry, seniority), with appropriate scores/ranks. In some embodiments, this ranking compares how frequently each term was found among relatively recent shares (e.g., within the past several hours, within the past day) in comparison to a longer past or preceding period of time (e.g., several days, a week).

Because the professional community may feature in the neighborhood of one million shares or share activities per day, a vast number of terms may be considered in order to find those that are “trending” or that are the most popular. Some insignificant terms (e.g., “and,” “or”) and/or popular terms that are unlikely to be trending for a significant/professional reason (e.g., “today,” “yesterday,” “X-rated”) may be omitted from the analysis.

For some or all of the ranked terms (e.g., the “trending terms”), the most significant or relevant shares are identified, which may be those that have contexts that include the term and that are most similar to other shares that mention the term. The relevant shares are then analyzed to identify individual entities (e.g., the “trending entities”). A given trending entity may include one or more of the trending terms, such as when the name of a frequently mentioned entity includes multiple words.

For each trending entity, one or more contexts among its relevant shares are selected for use as the reason for the entity's trendiness. Finally, co-trending entities may be identified by comparing different trending entities' reasons, and/or the contexts of their relevant shares. Co-trending entities may be merged into a single entity, may be presented together, or may be independent when a display of top trending entities is presented.

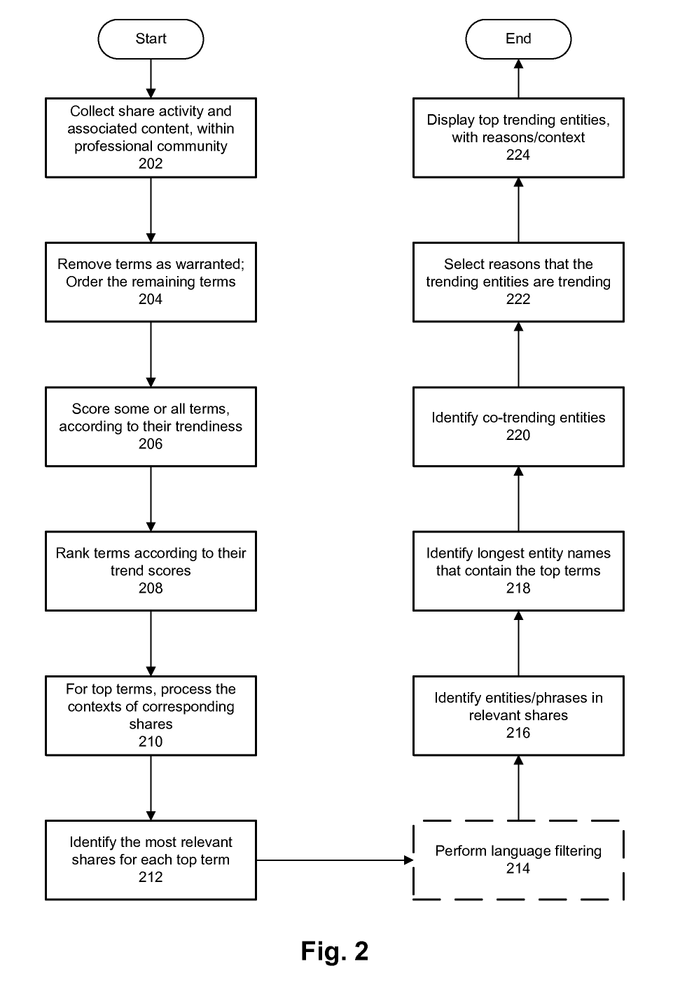

A detailed description of a process for identifying top trending entities in the professional world is now provided with reference to FIG. 2.

FIG. 2 is a flow chart illustrating a method of identifying entities trending within a professional community, according to some embodiments. In other embodiments, one or more of the illustrated operations may be omitted, repeated, and/or performed in a different order. Accordingly, the specific arrangement of steps shown in FIG. 2 should not be construed as limiting the scope of the embodiments.

In operation 202, share activity among members of the professional community is captured and recorded. In particular, whenever one member of the community shares (textual) content with one or more other members, that activity is recorded. Typically, a share activity will include some note, statement, comment, or other textual message from the sharing member, and may or may not refer to, or include a link to, other content (e.g., a news article, a web site, a post by another member of the community).

In some embodiments, share activity by different types of sharing members, and/or trending entities identified from the share activity, may be collected or stored separately depending based on industry, function (or job or role), seniority, education, employer, business segment, and/or other attribute(s). This may allow separate identification of trending entities in different industries, having different functions or seniority, and so on. In the currently discussed embodiments, however, share activity of multiple types of members (or of all members) is collected and analyzed together, and one set of entities trending throughout the professional community is presented.

In operation 204, contexts of the share activities (e.g., text entered by the sharing member) are parsed, and some terms may be dropped, such as stop words (e.g., “and,” “or,” “the”), common words that ordinarily are not part of the name or title of a trending entity (e.g., days of the week, months of the year, “today,” “tomorrow”), and so on. Abbreviations and misspellings may be eliminated, or may be analyzed to determine which terms they represent. Other words may be ignored or discarded for other reasons (e.g., relation to pornography or gambling, association with criminal activity).

The remaining terms are then processed to order them according their frequency of usage, such that the terms used most frequently in the collected share activities are ranked highest.

In operation 206, “trend scores” are calculated for some or all of the ordered terms—such as the top 10, top 50, top 100, or top 500. In the illustrated embodiments, the trend score (TS) of a term i is calculated as

$$TS ( i ) = \frac{{f}_{d} + N}{{f}_{w} + N} ,$$

wherein f_{d} is the frequency of usage of term i within the past day (e.g., 24 hours) or other relatively short time period (e.g., several hours, multiple days, a week), f_{w} is the frequency of usage of term i within the past week (e.g., 7 days, 168 hours) or other relatively long time period (e.g., multiple weeks, a month), and N is a smoothing factor for which an illustrative value is 500.

In some implementations, a count of the frequency of usage of a term for the preceding week (or other relatively long-term period) may include the day (or other relatively short-term period), such that f_{w} includes f_{d}. In other implementations, the time period associated with f_{w} precedes and does not overlap with the time period associated with f_{d}.

The smoothing factor allows a term whose percentage increase in popularity (from the previous week to the current day, for example) matches percentage increases of one or more other terms, but whose absolute number of appearances is greater, to receive a higher trend score. For example, assume two terms appeared twice as often in share activity in the past day as they appeared in the preceding week, but that the first term appeared in 1,000 shares in the past day (and 500 in the past week) while the second one appeared in only 50 shares in the past day (and 25 in the past week). Although their ratios of recent appearances to prior appearances are equal (i.e., 2:1), the first term or entity has been more popular than the second and should therefore have a higher score. The smoothing factor may differ in other embodiments by being smaller or greater in magnitude.

To support these calculations, frequency of usage data is kept for many words (e.g., over one hundred thousand English words) for the longest time period involved in the calculations.

In operation 208, the terms are ranked according to their trend scores. Some terms may be eliminated from further processing, such as all except the top 50, 100, or 200.

In operation 210, for each of the retained terms (which may be referred to as the “trending terms”)—such as the top 100—the context in which each term appeared in the corresponding share activity is examined. In particular, for each term, for each corresponding share (i.e., a share that included the term), the other words/terms of the share are collected and ordered by the frequency with which they appear among shares that mention the term. Put another way, for each trending term, each word included in the context of a corresponding share is ranked according to the total number of corresponding shares that included the word. Again, insignificant or unimportant words may be ignored.

As a result, for each trending term, a ranked collection has been amassed of words that accompanied the trending term in the shares that mentioned the trending term. These words may be called the trending term's context, and it may be noted that any given trending term may be part of the context of another trending term.

In operation 212, relevant shares for each trending term are identified—such as the top (or most relevant) 10, the top 20, etc. The most relevant shares are those share activities in which the share context (e.g., the textual content entered by the member that initiated the share) has the most in common with the trending term's context. In some implementations, for each corresponding share for a given trending term, the cosine similarity is calculated between the share's context and the term's context. Other measures of similarity may be applied in other embodiments (e.g., a Jaccard index or similarity coefficient, a simple matching coefficient).

Some context words may be weighted differently than others. For example, the highest rated or most common words of a trending term's context may be weighted more heavily than other words in the context, so that corresponding shares that match or include the more heavily weighted words are deemed more relevant than other corresponding shares.

In optional operation 214, some language filtering may be applied. For example, non-English trending terms (and associated contexts) may be dropped or ignored. In some other embodiments, however, terms and/or contexts may be translated, or separate processing may be applied to identify trending entities in different languages.

In operation 216, for each trending term, natural language processing and/or other processing is applied to identify entities and/or phrases within the relevant shares. For example, 3^{rd} party named-entity/phrase recognition software may be applied to accomplish this task. Multiple different forms or spellings of a given entity or phrase may be consolidated into one, or each variation may be retained.

For example, if an acronym and the full textual form of the entity name that is represented by the acronym are identified in operation 216, they may each be carried forward as separate entities, or one or the other may be dropped. In the latter situation, a determination as to which form to keep may depend on the frequency of usage of the two entities in the collected share activity, the length of the full name, and/or other factors.

In operation 218, for each trending term, the longest entity name/phrase identified in operation 216 that includes the term is identified. Thus, for a trending term that was a person's first name or last name, the longest entity name may be the person's full name (with or without the middle initial). For a trending term that is part of a product name, the longest entity name may be the full product name (e.g., including manufacturer, model number, version). For a trending term associated with an event or occurrence, the longest entity name may be a full or proper name of the event or occurrence.

As a result of operation 218, a set of trending entities has been identified. These entities may be ranked according to the trend scores of the trending terms that were subsumed into the entity names. For an entity that was identified with a name that included two or more trending terms, the entity's rank may be the higher trend score of the of the subsumed trending, an average of the terms' ranks, or may be determined in some other way.

In operation 220, for each trending entity, co-trending entities are identified, if any. In some embodiments, cosine similarities (or other similarity measurements) are made between a given trending entity's context and some or all other trending entities' contexts. If the similarity measurement is above a threshold for the given entity and another, they will be considered co-trending. In embodiments in which a cosine similarity is calculated, the measurement will be between 0 and 1, and a threshold of approximately 0.7 provides suitable results.

In some embodiments, co-trending entities are combined into groups or clusters. Any number of members of a single group may be included in a presentation of trending entities, depending on its trending score and/or the trending scores of other members of the same group. In some implementations, however, only one entity in a group of co-trending entities is displayed (e.g., the one with the highest score). The display of that entity could, however, link to a display of some or all other members of the same group.

In operation 222, “trending reasons” are selected for some or all of the trending entities. In the illustrated method, an entity's associated trending reason is an explanation or notation as to why the entity is trending, is drawn from its corresponding or relevant shares, and may even be copied from the text of one or more corresponding or relevant shares.

For example, if a particular relevant share's text contains the full (e.g., longest) name of the trending entity and has a high, or the highest, cosine similarity (or other similarity measurement) with the entity's context, that text may be adopted as the entity's reason. It may be copied verbatim or may be corrected (e.g., for grammar, spelling, punctuation). If a relevant share or a corresponding share included a link to a story, article, or other document, with a title or link that includes the full entity name and that is sufficiently similar to the entity's context, that link and its associated text may be adopted as the reason.

In some embodiments in which co-trending entities are identified before trending reasons are selected, an attempt may be made to select a reason that includes names of not only a target trending entity, but also some or all of its co-trending entities, if any, so that a display of the trending entity will directly lead a viewer to the co-trending entities.

In some other embodiments, trending reasons are selected for the trending entities before co-trending entities are identified (if any). In these embodiments, each trending entity may be kept separate, but a link or other connection may be maintained between them, so that if a user viewing the top trending entities clicks on an entry of a particular entity he or she may be offered information regarding the co-trending entity or entities.

In operation 224, a display of the top trending entities (e.g., the top 5, 10, or 20) is presented to a member or a user. In an illustrative implementation, each trending entity's entry in the display includes the name of the trending entity and the trending reason (which may also be a link to internal or external content—such as an article or a story—that describes or discusses the entity). The display may include other information, such as a trending entity's trend score, an indication as to whether its trendiness has increased or decreased since last measured, an industry in which the entity is primarily (or only) trending, etc.

After operation 224, the method ends.

In some embodiments, the method of FIG. 2 is applied multiple times per day (e.g., every four hours), and reflects trends over the preceding day (approximately 24 hours) in comparison to the preceding week. In other embodiments, the method may be applied with a different frequency and may consider share activity over different periods of time.

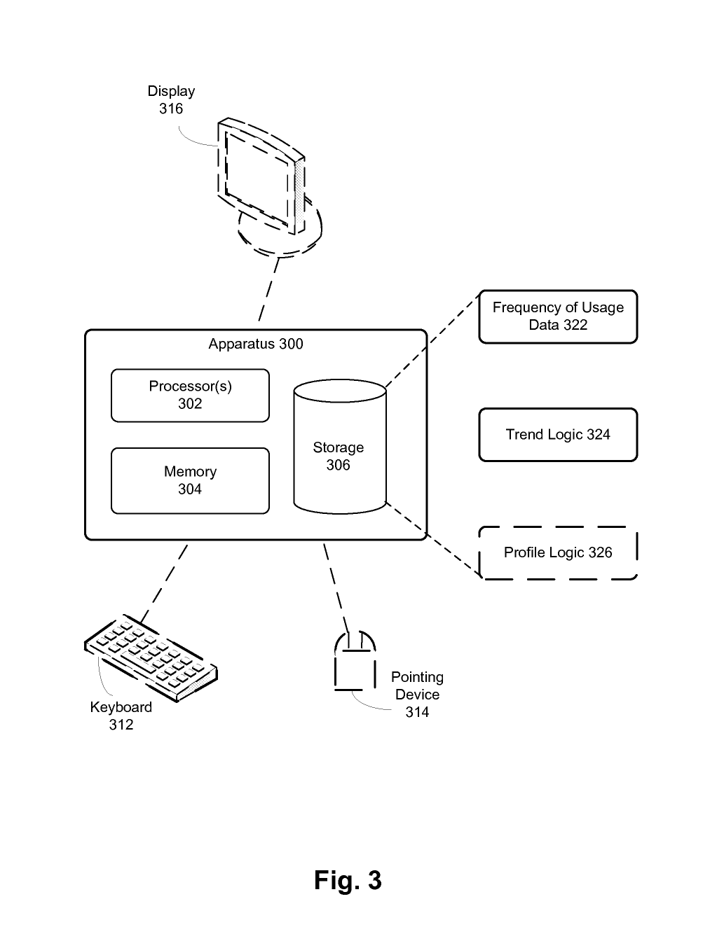

FIG. 3 is a block diagram of an apparatus for identifying entities that are trending in a professional community, according to some embodiments.

Apparatus 300 of FIG. 3 includes processor(s) 302, memory 304, and storage 306, which may comprise one or more optical, solid-state, and/or magnetic storage components. Storage 306 may be local to or remote from the apparatus. Apparatus 300 can be coupled (permanently or temporarily) to keyboard 312, pointing device 314, and display 316.

Storage 306 stores data used by the apparatus to support the identification and presentation of trending entities. Such data may include frequency of usage data 322 and/or other information.

Frequency of usage data 322 includes data identifying the frequency of usage of multiple words (e.g., tens or hundreds of thousands) over any suitable time period(s). Data 322 may be regularly augmented as new share activity is collected and processed, and may be regularly pruned as older share activities become obsolete or outdated.

In addition to data 322 storage 306 also stores logic that may be loaded into memory 304 for execution by processor(s) 302. Such logic includes trend logic 324 and may include optional profile logic 326. In other embodiments, a logic module may be divided to separate its functionality as desired, or multiple logic modules may be combined or merged.

Trend logic 324 comprises processor-executable instructions for processing share activity of any number of members of a professional community in order to identify entities that are trending within the community, according to the method depicted in FIG. 2 and/or other methods.

Thus, logic 324, when executed, may parse share activity to identify trending terms, score and rank them according to their usage, identify shares most relevant to the trending terms, identify names of trending entities, and provide a presentation of some number of the top trending entities.

Optional profile logic 326 comprises processor-executable instructions for using profiles of members of the professional community to characterize or categorize any or all of share activities, trending terms/entities, and contexts of shares and/or terms/entities. Thus, logic 326 may allow apparatus 300 to separately identify entities trending within different segments of the professional community.

In some embodiments, apparatus 300 performs some or all of the functions ascribed to one or more components of system 110 of FIG. 1.

An environment in which one or more embodiments described above are executed may incorporate a general-purpose computer or a special-purpose device such as a hand-held computer or communication device. Some details of such devices (e.g., processor, memory, data storage, display) may be omitted for the sake of clarity. A component such as a processor or memory to which one or more tasks or functions are attributed may be a general component temporarily configured to perform the specified task or function, or may be a specific component manufactured to perform the task or function. The term “processor” as used herein refers to one or more electronic circuits, devices, chips, processing cores and/or other components configured to process data and/or computer program code.

Data structures and program code described in this detailed description are typically stored on a non-transitory computer-readable storage medium, which may be any device or medium that can store code and/or data for use by a computer system. Non-transitory computer-readable storage media include, but are not limited to, volatile memory; non-volatile memory; electrical, magnetic, and optical storage devices such as disk drives, magnetic tape, CDs (compact discs) and DVDs (digital versatile discs or digital video discs), solid-state drives, and/or other non-transitory computer-readable media now known or later developed.

Methods and processes described in the detailed description can be embodied as code and/or data, which may be stored in a non-transitory computer-readable storage medium as described above. When a processor or computer system reads and executes the code and manipulates the data stored on the medium, the processor or computer system performs the methods and processes embodied as code and data structures and stored within the medium.

Furthermore, the methods and processes may be programmed into hardware modules such as, but not limited to, application-specific integrated circuit (ASIC) chips, field-programmable gate arrays (FPGAs), and other programmable-logic devices now known or hereafter developed. When such a hardware module is activated, it performs the methods and processed included within the module.

The foregoing embodiments have been presented for purposes of illustration and description only. They are not intended to be exhaustive or to limit this disclosure to the forms disclosed. Accordingly, many modifications and variations will be apparent to practitioners skilled in the art. The scope is defined by the appended claims, not the preceding disclosure.

What is claimed is:

1. A method, comprising:
recording textual content disseminated by members of a professional community;
identifying trending terms within the recorded textual content;
for each trending term:
identifying content disseminations that are most relevant to the trending term; and
within the relevant content disseminations, identifying at least one trending entity having a name that includes the trending term; and
presenting to a first member a display comprising:
multiple trending entities; and
for each trending entity, at least one reason the trending entity is trending.

2. The method of claim 1, wherein said identifying trending terms comprises:
collecting words used in the recorded content disseminations;
for each of multiple collected words, calculating a ratio of a short-term usage of the word to a long-term usage of the word; and
identifying N words having the highest calculated ratios (N>1);
wherein the trending terms are the N words.

3. The method of claim 2, wherein each of the short-term usage and the long-term usage is augmented by a smoothing factor prior to calculating the ratio.

4. The method of claim 2, wherein:
the short-term is approximately 24 hours; and
the long-term is approximately 7 days.

5. The method of claim 1, wherein identifying content disseminations relevant to a given trending term comprises:
collecting words used in content disseminations that mention the given trending term; and
for each content dissemination that mentions the given trending term, calculating a similarity between the content dissemination and the collected words;
wherein the M content disseminations (M>1) having the highest similarity to the collected words are the most relevant content disseminations.

6. The method of claim 1, further comprising, for each of multiple trending entities:
selecting, as the reason the trending entity is trending, text of a content dissemination that mentions the trending entity.

7. The method of claim 1, wherein the content disseminations comprise share activities of members of a social network.

8. The method of claim 1, wherein:
said recording content disseminations comprises, for each of multiple segments of the professional community, separately collecting content disseminations initiated by members of the multiple segments; and
said presenting comprises separately presenting top trending entities of one or more segments specified by the first member.

9. The method of claim 8, wherein the multiple segments are associated with different values of one or more of the following member attributes:
industry;
seniority;
function; and
organization size.

10. An apparatus, comprising:
one or more processors; and
memory storing instructions that, when executed by the one or more processors, cause the apparatus to:
record textual content disseminated by members of a professional community;
identify trending terms within the recorded textual content;
for each trending term:
identify content disseminations that are most relevant to the trending term; and
within the relevant content disseminations, identify at least one trending entity having a name that includes the trending term; and
present to a first member a display comprising:
multiple trending entities; and
for each trending entity, at least one reason the trending entity is trending.

11. The apparatus of claim 10, wherein said identifying trending terms comprises:
collecting words used in the recorded content disseminations;
for each of multiple collected words, calculating a ratio of a short-term usage of the word to a long-term usage of the word; and
identifying N words having the highest calculated ratios (N>1);
wherein the trending terms are the N words.

12. The apparatus of claim 11, wherein each of the short-term usage and the long-term usage is augmented by a smoothing factor prior to calculating the ratio.

13. The apparatus of claim 11, wherein:
the short-term is approximately 24 hours; and
the long-term is approximately 7 days.

14. The apparatus of claim 10, wherein identifying content disseminations relevant to a given trending term comprises:
collecting words used in content disseminations that mention the given trending term; and
for each content dissemination that mentions the given trending term, calculating a similarity between the content dissemination and the collected words;
wherein the M content disseminations (M>1) having the highest similarity to the collected words are the most relevant content disseminations.

15. The apparatus of claim 10, wherein the memory further stores instructions that, when executed by the one or more processors, cause the apparatus to, for each of multiple trending entities:
select, as the reason the trending entity is trending, text of a content dissemination that mentions the trending entity.

16. The apparatus of claim 10, wherein the content disseminations comprise share activities of members of a social network.

17. The apparatus of claim 10, wherein:
said recording content disseminations comprises, for each of multiple segments of the professional community, separately collecting content disseminations initiated by members of the multiple segments; and
said presenting comprises separately presenting top trending entities of one or more segments specified by the first member.

18. The apparatus of claim 17, wherein the multiple segments are associated with different values of one or more of the following member attributes:
industry;
seniority;
function; and
organization size.

19. A system, comprising:
one or more processors; and
a trend identification module comprising a non-transitory computer-readable medium storing instructions that, when executed, cause the system to:
record textual content disseminated by members of a professional community;
identify trending terms within the recorded textual content;
for each trending term:
identify content disseminations that are most relevant to the trending term; and
within the relevant content disseminations, identify at least one trending entity having a name that includes the trending term; and
present to a first member a display comprising:
multiple trending entities; and
for each trending entity, at least one reason the trending entity is trending.

20. The apparatus of claim 10, wherein the non-transitory computer-readable medium further stores instructions that, when executed by the one or more processors, cause the system to, for each of multiple trending entities:
select, as the reason the trending entity is trending, text of a content dissemination that mentions the trending entity.
